(19) United States
(12) Patent Application Publication
(10) Pub. No.: US 2010/0302139 A1
(43) Pub. Date: Dec. 2, 2010

(54) METHOD FOR USING ACCELEROMETER DETECTED IMAGINED KEY PRESS

(75) Inventors: Vesa Luiro, Berlin (DE); Markku Pulkkinen, Oulu (FI); Anssi Saarimaki, Berlin (DE); Antti Helander, Oulu (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/746,647

(22) PCT Filed: Feb. 21, 2008
(86) PCT No.: PCT/EP08/52125

§ 371 Date: Aug. 9, 2010

(30) Foreign Application Priority Data
Dec. 7, 2007 (US) 61012246

(51) Int. Cl. G09G 5/00; G06F 3/048

(52) U.S. Cl. 345/156; 715/702

(57) ABSTRACT

A portable apparatus comprising input means arranged to receive user input comprising of one or more taps on the portable apparatus. The apparatus is able to detect the taps on the portable apparatus and to determine at least one location of the taps on the portable apparatus. The apparatus is further able to define an imaginary key on the apparatus on the determined location.

### TECHNICAL FIELD

The present invention relates to methods for using vibration detector to add imaginary keys and to detect imaginary key presses on the casing, and/or the screen, of a handheld mobile communication apparatus.

### BACKGROUND OF THE INVENTION

Modern mobile communication apparatuses are capable of performing a multitude of complex tasks ranging from applications making voice calls, accessing web pages, send/receive e-mails, display live television, taking high resolution pictures, playing games and music, etc. To be able fully take advantage of the mobile communication apparatus capabilities, the apparatus must have an intuitive and user-friendly user-interface.

Entering text into the applications running in the mobile communication apparatuses, together with navigating and operating the same, are considered by many users to be the main bottlenecks in terms of usability. The main obstacle is that these apparatuses often only are equipped with a limited number of hardkeys such as a standard “phone keypad”, comprising ten keys (0-9) some functional keys, and a navigation device (joystick or four-way navigation button), for entering text and to navigate and operate the applications. This limitation leads to the need for long complex key press combinations to maneuver the application, which are both difficult to remember and easy to enter wrong. Thus, leading to a slow input speed and great frustration with the user.

If the mobile communication apparatus is equipped with a large touch-sensitive display, adding softkeys in the display can be one way of reducing the problem with the need for more hardkeys. However, display space is limited and therefore precious, and softkeys must often be operated using pen-type objects, which for many users is not optimal.

One way of reducing the problem would of course be to add more hardkeys to the apparatus, but factors such as cover and frame mechanics, design, and cost makes it nearly impossible to do that.

### SUMMARY OF THE INVENTION

In view of the above, an objective of the invention is to solve or at least reduce the problems discussed above. In particular, an objective is to provide a user-friendly way of adding user-configurable imaginary buttons, or keys, to the mobile communication apparatus to facilitate the navigation and operation of applications therein.

According to a first aspect of the present invention, there is provided a method for a portable apparatus, comprising enabling of said portable apparatus to receive a user input, wherein said user input comprise of one or more taps by a user on said portable apparatus, detection of said one or more taps on said portable apparatus using a vibration detector, determination of at least one location of said one or more taps on said portable apparatus, enabling of rendering of an application in said portable apparatus, and rendering of an application depending on said at least one location of said one or more taps on said portable apparatus.

In this way a tap on a predetermined position on the casing can be used as a virtual key press. In this way imaginary keys can be configured and located at any location on the casing of the apparatus without implementing any additional mechanics or electronics. The user can operate the imaginary keys either by tapping on the side of the casing or on the front of the casing.

The method may comprise detection of one or more taps tapped in sequence within a predetermined time frame. Thus different tapped sequences may be associated with different commands, which increase the number of commands that can be associated with tapping

The method may comprise an application rendered by said one or more taps in any combination with one or more movements of the portable apparatus.

The method may comprise an application rendered by said one or more taps in any combination with one or more key hold and/or key press. Thus tapping may be combined with usual key hold and/or key press actions.

The method may comprise that a detection of a tap is acknowledged to the user by any combination of a vibration indication, a visual indication, or an audio indication. Any of these indications offer useful feedback to the user since the user obtains the indication above as confirmation.

The method may comprise that one or more taps are located on the casing of the portable apparatus. Thus a user can for instance place imaginary keys on the casing.

The method may comprise that one or more taps on the portable apparatus are detected using at least two vibration detectors.

According to a second aspect of the present invention, there is provided a rendering application for a portable apparatus comprising a casing, a display, and navigation means, said application arranged to cause enabling of said portable apparatus to receive a user input, wherein said user input comprise of one or more taps by a user on said portable apparatus, the detection of said one or more taps on said portable apparatus using a vibration detector, the determination of at least one location of said one or more taps on said portable apparatus, the enabling of rendering of an application in said portable apparatus, and the rendering of an application depending on said at least one location of said one or more taps on said portable apparatus.

According to a third aspect of the present invention, there is provided a casing, a display, a vibration detector, and input means arranged to receive a user input, wherein said user input comprise of one or more taps by a user on said portable apparatus, and further arranged to detect said one or more taps on said portable apparatus using a vibration detector, and determining at least one location of said one or more taps on said portable apparatus. It is further arranged to enabling rendering of an application in said portable apparatus, and rendering of an application depending on said at least one location of said one or more taps on said portable apparatus. The vibration detector may be comprised on a main printed circuit board of the apparatus. The vibration detector may sense vibration along at least two axes. More particularly it may sense vibration along three axes. The apparatus may further comprise at least a second vibration detector. Thus the method for may be implemented in a portable apparatus as disclosed above and the apparatus may be realized by a casing, a display, a vibration detector and input means.

According to a fourth aspect of the present invention, there is provided a computer-readable medium having computer-executable components comprising instructions for enabling said portable apparatus to receive a user input, wherein said user input comprise of at one or more taps by a user on said portable apparatus, detecting said one or more taps on said portable apparatus using a vibration detector, determining at least one location of said one or more taps on said portable apparatus, enabling rendering of an application in said portable apparatus, and the rendering of an application depending on said at least one location of said one or more taps on said portable apparatus.

According to a fifth aspect of the present invention, there is provided a user interface comprising a casing, a display, and an input receiver, wherein said user interface is arranged to, enable said portable apparatus to receive a user input, wherein said user input comprise of at one or more taps by a user on said portable apparatus, detecting said one or more taps on said portable apparatus using a vibration detector, determining at least one location of said one or more taps on said portable apparatus, enabling rendering of an application in said portable apparatus, and rendering of an application depending on said at least one location of said one or more taps on said portable apparatus.

The second, third, fourth, and fifth aspects of the present invention may be combined in any way with the features of the first aspect of the present invention.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated,

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 shows a mobile communication apparatus according to an embodiment of the present invention; and

FIG. 2 shows another mobile communication apparatus according to an embodiment of the present invention; and

FIG. 3a shows a display view of a handheld communication apparatus according to an embodiment of the present invention; and

FIG. 3b shows another display view of a handheld communication apparatus according to an embodiment of the present invention; and

FIG. 3c shows another display view of a handheld communication apparatus according to an embodiment of the present invention; and

FIG. 3d shows another display view of a handheld communication apparatus according to an embodiment of the present invention; and

FIG. 4 shows another display view of a handheld communication apparatus according to an embodiment of the present invention; and

FIG. 5 shows another display view of a handheld communication apparatus according to an embodiment of the present invention; and

FIG. 6 illustrates a computer readable medium according to an embodiment of the present invention; and

FIG. 7 illustrates a user interface of the present invention.

### DETAILED DESCRIPTION OF PREFERRED EMBODIMENTS

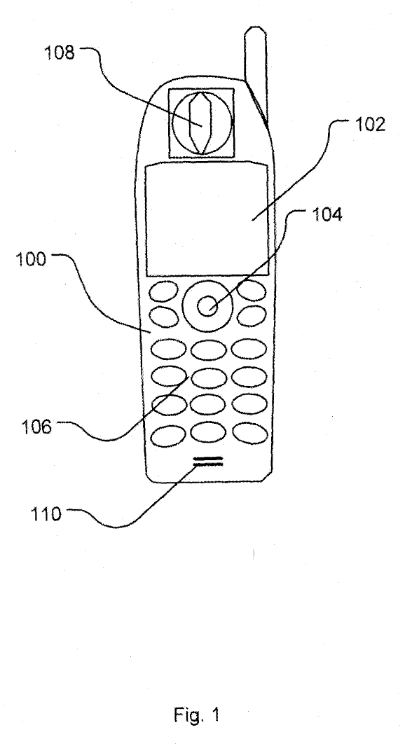

FIG. 1 shows a typical mobile communication apparatus 100 comprising a display 102 and means 104 for navigating among items (not shown) displayed in a display area 102. The navigation means 104 may be a rotating input, a joystick, a touch pad, but may also be implemented using a touch-sensitive display, or be voice activated via a headset or a built-in microphone 110.

The mobile communication apparatus can also comprise other elements normally present in such an apparatus, such as a keypad 106, a speaker 108, a microphone 110, an accelerometer (not shown), a vibration device (not shown), a processor (not shown), a memory (not shown), etc.

There are several problems associated with this type of mobile communication apparatus. For instance the keypad 106, with a limited number of hardkeys, and the navigation means 104 are the only means at disposal for a user to enter, maneuver, and navigate information displayed on the display 102. This makes text entering and navigation especially cumbersome. Another problem is which hardkeys to use in the maneuvering and navigation process. Since most of the hardkeys are not placed in the vicinity of the display 102, it can be quite confusing for a user to which hardkeys to use. The traditional solution to the problem of not having enough hardkeys, is to use different sequences or combinations of key presses to simulate an additional hardkey. However, this approach often leads to slow input speed and it also dramatically increases the possibility to enter the wrong combination of key presses.

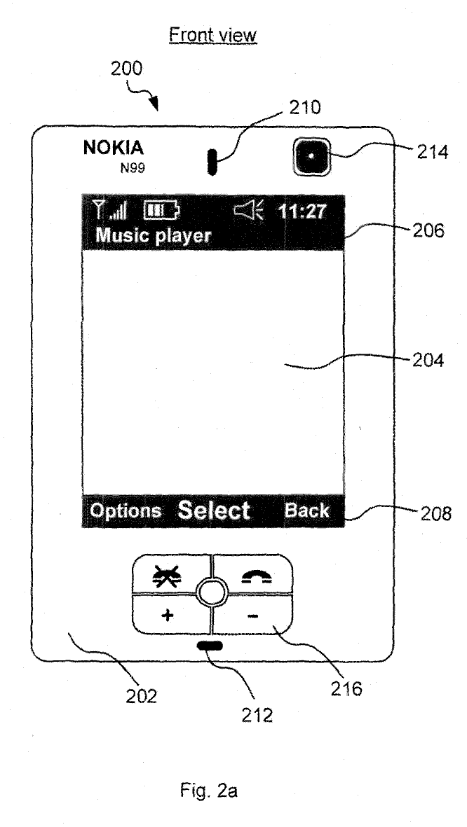

FIG. 2a shows a front view of another type of a mobile communication apparatus 200, which is often referred to as a Personal Digital Assistant (PDA) type of mobile communication apparatus.

In this example the front view of the PDA comprise a front casing 202 with a large display screen 204 which can be touch-sensitive. In this example the display screen 204 displays a general softkey bar 208 and a general status indication area 206. The general status indication area 206 can for example include symbols for battery status, reception quality, speaker on/off, present mode, time and date, etc. The status indication section is not in any way limited to only include these symbols. Thus, other symbols in any shape, form or color can occur. The softkey bar 208, in this example situated at the bottom of the display view, is operable by using the navigation means 216 or, if using a touch sensitive screen, by tapping the softkey with a pen-like object, such as a stylus, a finger, or another body part. The functions of these softkeys are not limited by the functions indicated in the figure. Neither are the placements of the general softkey bar 208 and a general status indication area 206 limited to the bottom and the top of the screen as shown in the example.

The navigation means 216 can for instance be used to navigate items displayed on the screen 204, or to perform basic functions, such as activating the phone when receiving a call.

The mobile communication apparatus 200 may also comprise other elements normally present in such an apparatus, such as a front casing 202, a speaker 210, a microphone 212, a camera 214, one or more sensors and detectors (not shown), arranged to detect all or some of the quantities vibration, motion, heat, or pressure, a vibration device (not shown), a processor (not shown), a memory (not shown), etc.

FIG. 2b shows a side view of the mobile communication apparatus 200 presented in FIG. 2a, comprising of a side portion of the casing 201, a battery cover 205, a side view of the navigation means 203, protruding from the front cover 202 (same as the navigation means 216 in the front view in FIG. 2a), and a maneuverable button 207.

The navigation and maneuvering of the applications in the PDA type mobile communication apparatus, shown in FIGS. 2a and 2b, is generally not done in the same manner as in the mobile communication apparatus discussed in conjunction with FIG. 1. The PDA type apparatus is mainly operated using softkeys, which are displayed on the touch-sensitive display 204. Applications running on the PDA display their own set of softkeys, which can be operated using a finger or a pert-type object as disclosed above. Since the softkeys are displayed on the screen in an application-specific environment, they are much more intuitive to the user in comparison to the placement of the hardkeys discussed in conjunction with FIG. 1. However, display-space is limited and if an application requires several maneuverable softkeys to be displayed at the same time, the displayed softkeys tend to be made small and therefore very hard to maneuver. A large amount of softkeys will also consume valuable display-space, leaving less room for the application to display other content at the same time.

Several embodiments of the present invention will now be exemplified using the drawings of the PDA type mobile communication apparatus as previously exemplified in FIGS. 2a and 2b. However, all of the embodiments of the present invention can also be realized using any other type of handheld communication apparatus, laptop computer, or any other type of mobile computer apparatus.

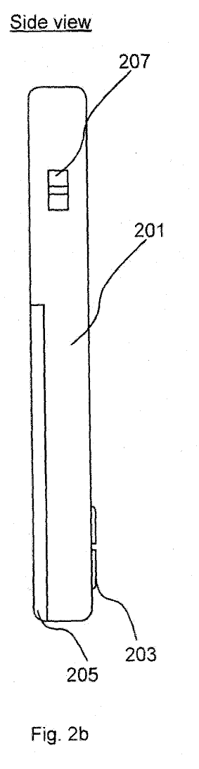

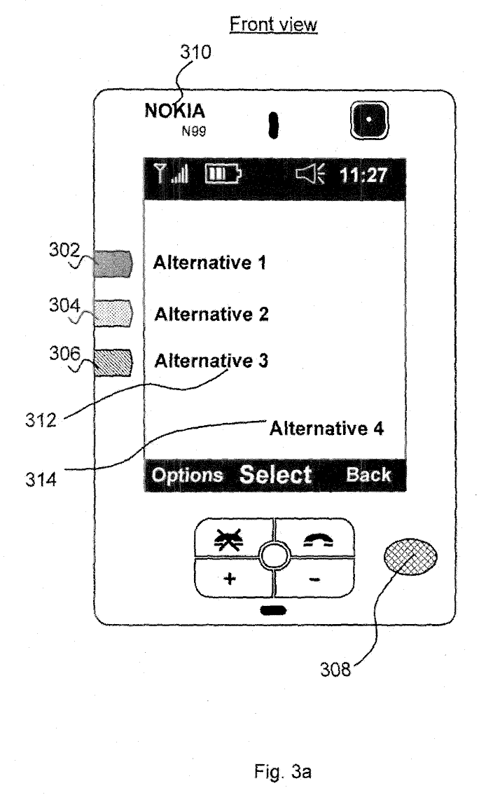

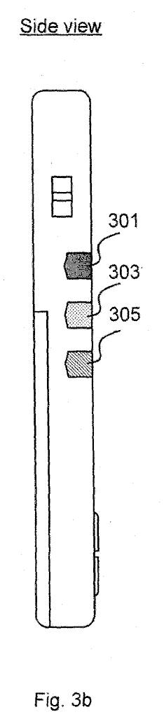

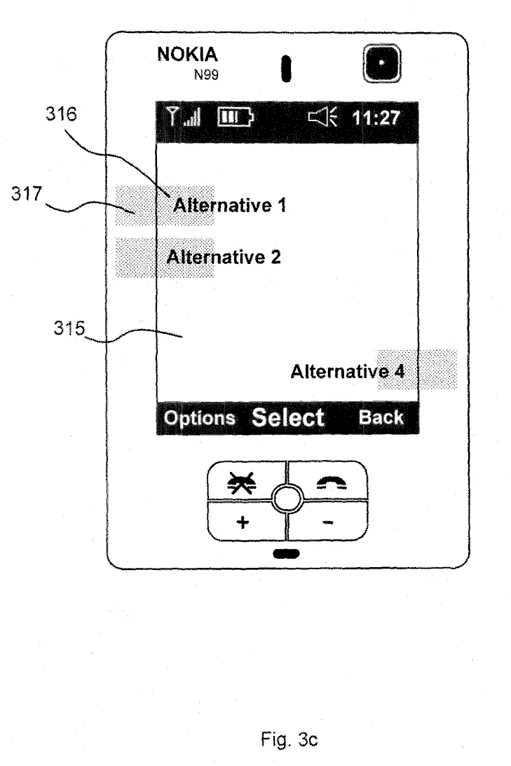

FIGS. 3a and 3b shows an embodiment of the present invention. To avoid the problem of having to use long and complex key press combinations to simulate an additional hardkey, or to avoid the problem of crowding the display with many softkeys, one or more sensors and detectors, detecting vibrations (such as by an accelerometer), motion, pressure, or heat, can be used.

All embodiments of the present invention will hereinafter be described using vibration detection as the main type of sensor and detector technique. However, it should be understood that the present invention could also be implemented using sensors and detectors capable of detecting all or some of the quantities; vibrations, motion, pressure, or heat.

The main sensor could for example be a triple-axes MEMS (Micro-Electro-Mechanical Systems) accelerometer. Furthermore, the sensor may be active in a situation when a possible command is likely to occur. Likewise the sensor may be deactivated in a situation when a possible command is not likely to occur. Hence such an activating and deactivating strategy will be beneficiary for the power consumption, which is of importance since mobile communication apparatus usually have limited power resources.

The detected vibrations may pertain to a resonant frequency signal associated with each axis. As an example each such signal may be recorded every 300 ms. Characteristics of these signals may then be matched to characteristics of pre-recorded signals in order to match a vibration to a location of origin.

The detectors, in this case vibration detectors, are able to detect vibrations in/on the apparatus of at least two axes, preferably three axes, and to pinpoint, in all three dimensions, the origin or position of the vibration. They are also capable of detecting the force of the percussion, which allows the apparatus to differentiate between a hard and a soft tap. In this way a tap on a predetermined position on the casing can be used as a virtual key press. In this way imaginary keys can be configured and located ail over the casing of the apparatus without implementing any additional mechanics or electronics.

The vibration detector may be comprised on the main PCB (printed circuit board) of the apparatus. Having the vibration detector comprised in the main phone PCB has the added advantages of providing a compact, cheap, and solid solution, which in addition allows for easy assembly.

There may be several detectors cooperating to determine the location of origin of a vibration. For example, a first vibrator may detect a fundamental vibration whilst a second vibrator may detect a harmonic vibration, or an echo vibration.

FIG. 3a shows a mobile communication apparatus with markings at three locations 302, 304 and 306 on its casing. When a user taps one of these markings with his finger or a pen-like object, an accelerometer, receding inside the apparatus, will detect the position and force of the tap, and interpret it as a key press, and consequently maneuver the application in the same manner as if the user had pushed a real mechanical hardkey.

As shown in FIG. 3a, the running application can also display labels 312 explaining the function of the imaginary keys at a particular time. Having imaginary keys on the casing alongside the labels 312 will both save precious display space and make the imaginary keys intuitive to use for the user.

The marking can either be put on the casing during manufacturing or be added by the user. Another possibility is to sell interchangeable covers together with a specific application, e.g. a software application. In this way a customized casing with pre-marked imaginary keys is provided for a particular application.

Not only the casing at the side of the display can be marked and configured to function as a virtual key. For example FIG. 3a shows a virtual key, which is located in the lower right corner of the casing 308. Even the sides or the backside of the casing can be used to place imaginary keys on.

FIG. 3b shows a side view of the apparatus in FIG. 3a. As shown in the figure the markings on the apparatus casing, coming from the front casing, may extend around the edge of the casing, allowing the imaginary keys to extend to the side of the casing 301, 303, and 305, In this way the user can operate the imaginary keys either by tapping on the side of the casing or on the front of the casing, i.e. on the location of the imiginary key. Also, if the user has the apparatus in a one-hand grip, with its backside resting in his/hers palm, he/she can easily tap with his/hers fingers on the side of the casing, thus operate the imaginary keys with only one hand.

FIG. 3c shows another embodiment of the present invention. In this example the casing is utilized as an extension of the display (being non- or touch-sensitive display). The application running in the mobile communication apparatus displays a selectable alternative, ‘Alternative 1’ on the display 315. The selectable softkey area belonging to the alternative 316 is clearly marked on the screen. The displayed marking 316 is stretched out onto the casing and blends together with the casing marking 317. The marking on the casing 317 have preferably the same color and shape as the marking 316 in the display. This will indicate to the user that the selectable area is in fact both the touch-sensitive area on the display and the marked area on the casing. Thus, the operable area can be viewed as enlarged, extending beyond the touch-sensitive screen onto the casing. This is very convenient if the alternatives crowd the display area, or if the descriptive alternative texts are very long and need lots of display-space.

The markings for tappable positions do not need to be in the form of geometric shapes of various colors or forms. Also printed text and company logos put on the casing can be utilized. When for instance the company name Nokia 310, shown in FIG. 3d, is tapped by a user an application is rendered which connects to the Internet, launches a browser, and accesses the Nokia N99homepage. If for instance a serial number on the backside of the apparatus is tapped an application is rendered which launches a browser connecting to a homepage containing the newest software updates for the apparatus in questions. It could also connect to an Internet store, which sells downloadable applications, and accessories to that particular model.

The casing does not need to be marked to contain imaginary keys. A user can for instance place imaginary keys on the casing. These un-marked keys can be used as secret imaginary keys, which can be used when entering a password to an application. The coordinates of the secret keys on the casing can in this case be translated into a sequence of letters and numbers making up a password.

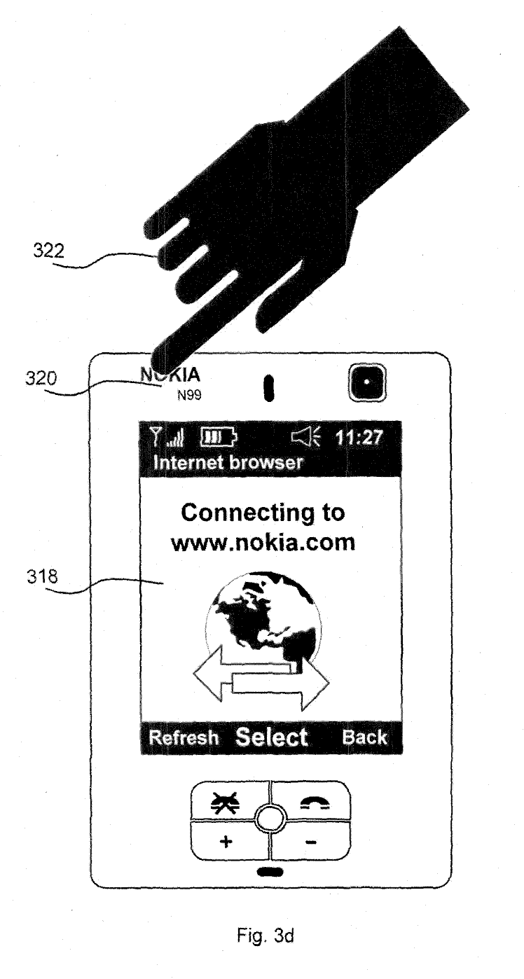

FIG. 4 shows yet another embodiment of the present invention. In this figure the mobile communication apparatus has been divided into four parts or zones as indicated by the dotted lines 401 and 402 in FIG. 4. The apparatus displays four options 404, 406, 408 and 410; one in each zone, as softmenus on the display. Each zone can then be associated to the option present in that particular zone. For example, softmenu ‘Option 1’ 504 is associated with zone 1, softmenu ‘Option 2’ 408 is associated with zone 3, and so on. The displayed options are then chosen or maneuvered when a user taps anywhere inside the particular zone, both screen and casing, belonging to that option. For example, if a user wants to select ‘Option 3’ 406 he/she taps either the touch-sensitive screen inside zone 2 or the casing inside zone 2. Either of the taps will render ‘Option 3’ 406. Even the sides and back of the mobile communication apparatus can be divided and included into zones. For example, if a user taps on the lower left corner of the backside of the apparatus ‘Option 3’ 408 will be selected.

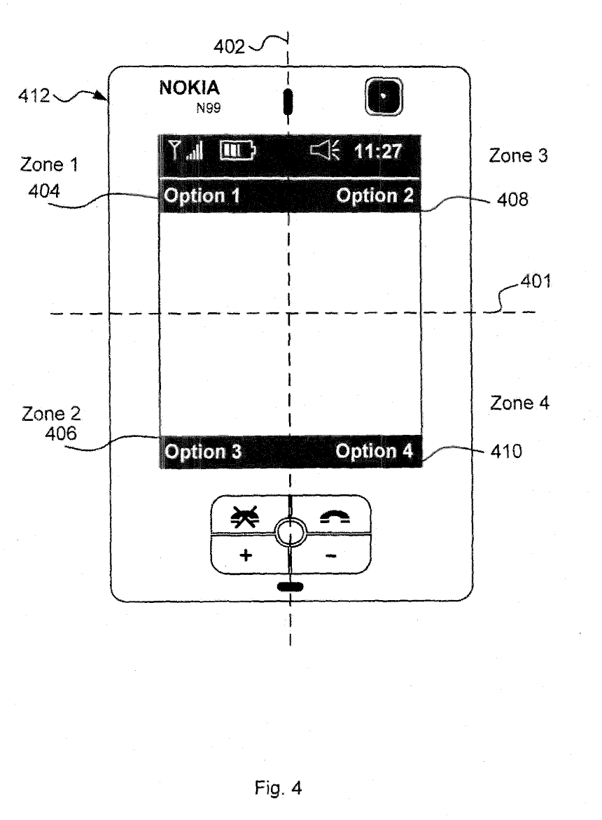

FIG. 5 shows yet another embodiment of the present invention where another but similar division, compared to the division presented in FIG. 4, of the mobile communication apparatus into four parts or zones, separated by the doted lines 500 and 501, has been done. In this example the zones are not connected to a specific softmenu, but instead to selectable objects, such as ‘Alt. 2’, displayed inside each zone, When the area, display area or casing area, within that zone is tapped the corresponding alternative, ‘Alt. 2’ 502 in this case, is rendered.

It should be noted that the embodiments of the invention presented in FIG. 4 and FIG. 5 is not limited by their respective examples. The mobile communication apparatus can be divided into two or more parts or zones. Each zone can be pre-marked or user marked with a corresponding color or theme, or not marked at all. The borders between the zones may be marked or not, and the borders can either be soft or hard, meaning that if a user taps right on the border between one or more zones, rules governing which zone is to be considered to be tapped can be laid out in a more or less strict matter. The division into zones does not have to be done in shapes (squares as shown in FIGS. 4 and 5) separated by straight lines (imaginary lines), the could in fact be done in any shape or form.

The vibration detector may also be able to detect both heat and/or pressure from the user's fingers when tapping the casing. This can be utilized to further filter out unwanted tap “noise”.

The vibration detector may also be able to detect motions of the handheld communication apparatus. A moving motion of the apparatus can for instance be utilized together with taps to maneuver an application. A side-to-side motion can for example trigger browsing of documents in an archive, while a tap selects the displayed document for reading/editing. A tap/motion detection program running in the mobile communication apparatus can be configured to filter out a tap/motion from other vibrations and motion noise.

Since pushing an imaginary key does not provide the same bio-feedback as pushing a mechanical key other indications to the user that the imaginary key has been pushed successful may be provided. The indication of a successful key press may be in the form of a vibration of the apparatus, an audio signal, or a visual indication such as flashing the display or blinking with an light emitting diode.

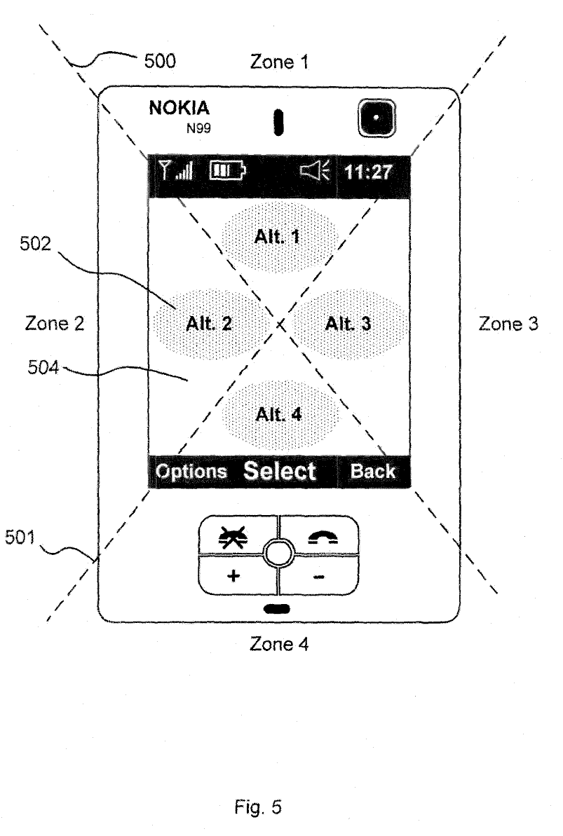

The invention can be computer-implemented, i.e. the media handling is performed on a general or dedicated computerized apparatus 601, such as a personal computer, a mobile phone, a digital camera, a personal digital assistant, a media player, or other similar apparatus. Instructions for performing the invention can then be executed by the apparatus. These instructions can be loaded into the apparatus 601 from a computer-readable medium 602, as exemplary illustrated in FIG. 6, having a data structure stored. The data structure comprises the control instructions, which upon execution causes the apparatus to perform any of the embodiments of the present invention as described above.

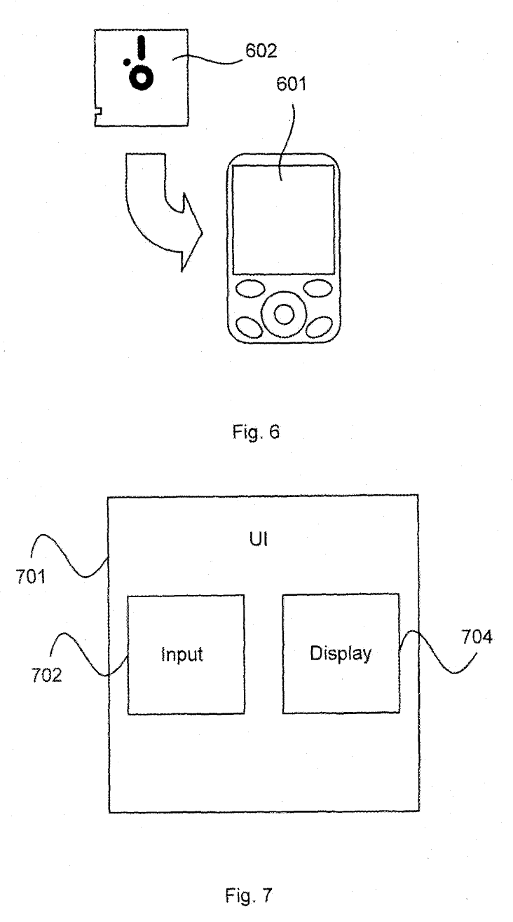

FIG. 7 illustrates a user interface (UI) 701 in a portable apparatus having an input interface 702, which as described in above embodiments can be actuated by a user, and a display interface 704 for displaying information to the user as described in the above embodiments of the present invention.

The invention presented above is beneficial in many ways. Persons with large fingers, or with gloves, or have deficient motor skills will greatly benefit from the greater and sensitive adjustable tapping area. An application developer and/or a user can define application specific virtual keys in any shape, size, or form.

The present invention can also replace the touch-sensitive screen, which are more expensive to use, consumes more power, and has a shorter lifespan than an ordinary display. The invention can also replace ordinary mechanical buttons, which are both costly to implement, takes up space both inside and outside of the apparatus, and wears quickly out, especially in harsh conditions. The invention can therefore be especially effective in the making of apparatuses for usage in tough conditions such as in heavy industry and military applications and even in outdoor applied consumer products.

While the embodiments of the present invention have been described with specificity to handheld communication devices, other types of computing devices with which the embodiments can be used will occur to those skilled in the art. For example, a personal computer can benefit from the invention in the same manner as the handheld communication device. Further, while the illustrated embodiments discusses the use of user-configurability, the user-configurability may be implicit or provided in some other manner than described above. The above-described embodiments of the invention are intended to be examples of the invention and alterations and modification may be affected thereto, by those skilled in the art, without departing from the scope of the invention, which is defined solely by the claims appended hereto.

1-38. (canceled)

39. A method, comprising:
receiving user input, wherein said user input comprises one or more taps on a portable apparatus;
detecting said one or more taps on said portable apparatus;
determining at least one location of said one or more taps on said portable apparatus; and
defining an imaginary key on said portable apparatus at said at least one determined location.

40. The method according to claim 39, further comprising:
executing an application when said imaginary key on said portable apparatus is tapped.

41. The method according to claim 39, wherein said one or more taps are received in sequence within a predetermined time frame.

42. The method according to claim 41, wherein said one or more taps are received at a same location of said portable apparatus.

43. The method according to claim 41, wherein said one or more taps are received at different locations of said portable apparatus.

44. The method according to claim 39, wherein said one or more taps are received simultaneously at different locations.

45. The method according to claim 40, wherein said application is executed when said imaginary key is tapped in combination with one or more movements of the portable apparatus.

46. The method according to claim 40, wherein said application is executed when said imaginary key is tapped in combination with one or more key hold(s) and/or key press(es).

47. The method according to claim 39, further comprising acknowledging said detection of said one or more taps by at least one of a vibration indication, a visual indication, and an audio indication.

48. The method according to claim 39, wherein said imaginary key is located on a casing of the portable apparatus.

49. The method according to claim 48, wherein said imaginary key is marked by a marked area proximate to said imaginary key.

50. The method according to claim 39, wherein said one or more taps are detected using at least one vibration detector.

51. An apparatus comprising
at least one processor; and
at least one memory including computer program code;
the at least one memory and the computer program code configured to, with the at least one processor, cause the apparatus at least to perform:
receiving user input, wherein said user input comprises one or more taps on the portable apparatus;
detecting said one or more taps on said portable apparatus;
determining at least one location of said one or more taps on said portable apparatus; and
defining an imaginary key on said apparatus at said at least one determined location.

52. The apparatus according to claim 51, wherein the at least one memory and the computer program code are further configured to, with the at least one processor, cause the apparatus to execute an application when said imaginary key on said portable apparatus is tapped.

53. The apparatus according to claim 52, wherein the at least one memory and the computer program code are further configured to, with the at least one processor, cause the apparatus to execute said application when said one or more taps are received in sequence within a predetermined time frame.

54. The apparatus according to claim 52, wherein the at least one memory and the computer program code are further configured to, with the at least one processor, cause the apparatus execute said application when said imaginary key is tapped in combination with one or more movements of the portable apparatus.

55. The apparatus according to claim 52, wherein the at least one memory and the computer program code are further configured to, with the at least one processor, cause the apparatus to execute said application when said imaginary key is tapped in combination with one or more key hold(s) and/or key press(es).

56. The apparatus according to claim 51, further comprising a vibration detector embedded on a main printed circuit board of said apparatus, wherein said one or more taps are detected by the vibration detector.

57. The apparatus according to claim 51, further comprising a device for acknowledging a detection of a tap by at least one of a vibration indication, a visual indication, and an audio indication.

58. A computer-readable medium having computer-executable components comprising instructions for enabling said portable apparatus to receive user input, wherein said user input comprises one or more taps on said portable apparatus;
detecting said one or more taps on said portable apparatus;
determining at least one location of said one or more taps on said portable apparatus; and
defining said imaginary key on said portable apparatus on said at least one determined location.
